(19) United States
(12) Patent Application Publication
(10) Pub. No.: US 2012/0024405 A1
(43) Pub. Date: Feb. 2, 2012

(54) GUIDING DEVICES AND METHODS OF MAKING AND USING THE SAME

(75) Inventors: Christoph Boeld, Munich (DE); Victor Donald Samper, Kirchseeon (DE); Christian Rensch, Munchen (DE); Ruben Julian Horvath-Klein, Munchen (DE)

(73) Assignee: GENERAL ELECTRIC COMPANY, SCHENECTADY, NY (US)

(21) Appl. No.: 13/086,139

(22) Filed: Apr. 13, 2011

Related U.S. Application Data
(63) Continuation-in-part of application No. 12/844,385, filed on Jul. 27, 2010.

(51) Int. Cl. F16L 37/00

(52) U.S. Cl. 137/614

(57) ABSTRACT

A fluid connector device is provided. The fluid connector device comprises a coupling substrate comprising a conformal recess, a reconnectable fitting corresponding to the conformal recess, and a guiding device. The guiding device comprises a base component, a body at least partly disposed in the base component and comprising a broad end and a narrow end, wherein the broad end is disposed away from the coupling substrate, and wherein the body is slidably disposed in the base component, and a resilient component disposed on the body of the guiding device and configured to move the reconnectable fitting one or more degrees in a translational, or a rotational direction, or both, relative to the coupling substrate. The fluid connector device further comprises a force applying element operatively coupled to the guiding device, the coupling substrate, or both, to at least partially provide a sealing force between the reconnectable fitting and the coupling substrate, wherein at least one of the force applying element, the reconnectable fitting, and the coupling substrate are adapted to move one or more degrees to enable self-alignment between the reconnectable fitting and the conformal recess.

### CROSS-REFERENCE TO RELATED APPLICATION

The present invention is a continuation-in-part of and claims priority to U.S. patent application Ser. No. 12/844,385, filed Jul. 27, 2010.

### BACKGROUND

Embodiments of the invention relate to miniature fluidic devices, such as microfluidic devices, and more particularly, to guiding devices for fluidic connectors for introducing fluids in miniature fluidic devices.

Typically, microfluidic devices employ networks of chambers that are connected by microchannels. The microchannels and chambers may have meso-scale to micro-scale dimensions. Microfluidic devices, offer various advantages, including the ability to use small sample sizes. For example, the sample sizes for the microfluidic devices may be on the order of nano-liters.

Advantageously, the microfluidic devices may be produced at a relatively low cost, and may perform numerous specific operations, including mixing, dispensing, reacting, and detecting. However, introducing fluid samples and reagents into the microfluidic devices is a challenge, especially when multiple inputs are required. For example, in a lab-on-a-chip setting, there is a need to connect the microfluidic chip to input and output interfaces. Connecting the microfluidic chip or connecting the microchannels within the chip to other input and/or output interfaces may pose problems due to small size (typically ranging from a few micrometers in width or diameter to tens or hundreds of micrometers) of the microchannels. In addition, it may be difficult to, for example, align input devices with the small-sized microchannels. Also, some of the input devices, e.g. liquid chromatographs, work at high pressures and it may be difficult to prevent leakage when using such input devices.

A common technique used in the past for interfacing the microfluidic devices to each other and to the outside world involves bonding a length of tubing of the input and/or output devices to a port on the microfluidic device. Usually, the tubing is bonded to the port on the microfluidic device using a suitable adhesive, such as epoxy. However, adhesive bonding is unsuitable for many chemical analysis applications because the solvents used in bonding may introduce impurities in the chemical sample. Further, the solvents used for bonding may attack the adhesive, which can lead to detachment of the tubing, channel clogging, and/or contamination of the sample and/or reagents delivered to the microfluidic device. Moreover, adhesive bonding, such as epoxy bonding, provides a permanent joint, thereby reducing the probability of having a reconfigurable device. For example, the permanent joint makes it difficult to change components, e.g. either the microfluidic device or the tubing, if necessary. Thus, assembly, repair and maintenance of such devices become labor and time intensive, a particularly undesirable feature when the microfluidic device is used for high throughput screening of samples such as, drug discovery, or in research environment, where reconfigurability of interfacing devices is useful.

To overcome problems associated with adhesive bonding, others have press fit the tubing into a port on the microfluidic device. However, such a connection is unsuitable for high-pressure applications such as high-pressure liquid chromatographs. Also, such connections have very low tolerances. Low tolerances pose a challenge in systems that employ multiple connectors for devices (e.g. scale up). Such connections also require high sealing forces that sometimes cause the microfluidic chip to crack.

Other methods involve introducing liquids into an open port on the microfluidic device using an external delivery system such as a pipette. In these methods, connection to the ports on the microfluidic device is typically by means of a micropipette end. However, this method is also undesirable due to leaks and spills that may lead to contamination. In addition, the fluid is delivered discretely rather than continuously. Moreover, the open pipetting techniques do not permit the use of elevated pressure for fluid delivery such as delivery by a pump, thereby further restricting the applicability of the microfluidic device.

Therefore, there exists a need for an improved fluid connector device configured to self-align with the microfluidic device, while providing an effective, high pressure, low fluid dead volume seal.

### BRIEF DESCRIPTION

In one embodiment, a fluid connector device is provided. The fluid connector device comprises a coupling substrate comprising a conformal recess, a reconnectable fitting corresponding to the conformal recess, and a guiding device. The guiding device comprises a base component, a body at least partly disposed in the base component and comprising a broad end and a narrow end, wherein the broad end is disposed away from the coupling substrate, and wherein the body is slidably disposed in the base component, and a resilient component disposed on the body of the guiding device and configured to move the reconnectable fitting one or more degrees in a translational, or a rotational direction, or both, relative to the coupling substrate. The fluid connector device further comprises a force applying element operatively coupled to the guiding device, the coupling substrate, or both, to at least partially provide a sealing force between the reconnectable fitting and the coupling substrate, wherein at least one of the force applying element, the reconnectable fitting, and the coupling substrate are adapted to move one or more degrees to enable self-alignment between the reconnectable fitting and the conformal recess.

In another embodiment, a fluid connector assembly is provided. The assembly comprises a coupling substrate having a first surface and a second surface, the coupling substrate comprising one or more conformal recesses on the first surface, one or more reconnectable fittings that are configured to be at least partially disposed in the conformal recess to provide a passageway between the microfluidic device and the reconnectable fittings such that the reconnectable fittings are in fluidic communication with the microfluidic device, a guiding device for guiding the reconnectable fitting in the conformal recess for removably coupling the reconnectable fitting to the conformal recess, a force applying element operatively coupled to the guiding device, the coupling substrate, or both. The guiding device comprises a base component, a body at least partly disposed in the base component and comprising a broad end and a narrow end, wherein the broad end is disposed away from the coupling substrate, and wherein the body is slidably disposed in the base component, and a resilient component disposed on the body of the guiding device and configured to move the reconnectable fitting one or more degrees in a translational, or a rotational direction, or both, relative to the coupling substrate.

In yet another embodiment, an adapter kit for introducing and/or extracting fluids from a microfluidic device. The adapter kit comprises a coupling substrate having a first surface and a second surface, wherein the first surface comprises a conformal recess, a reconnectable fitting corresponding to the conformal recess, a guiding device, and a force applying element operatively coupled to the guiding device, the coupling substrate, or both, to at least partially provide a sealing force between the reconnectable fitting and the coupling substrate, wherein at least one of the force applying element, the reconnectable fitting, and the coupling substrate are adapted to move one or more degrees to enable self-alignment between the reconnectable fitting and the conformal recess. The guiding device comprises a base component, a body at least partly disposed in the base component and comprising a broad end and a narrow end, wherein the broad end is disposed away from the coupling substrate, and wherein the body is slidably disposed in the base component, and a resilient component disposed on the body of the guiding device and configured to move the reconnectable fitting one or more degrees in a translational, or a rotational direction, or both, relative to the coupling substrate.

### DRAWINGS

These and other features, aspects, and advantages of the invention will become better understood when the following detailed description is read with reference to the accompanying drawings in which like characters represent like parts throughout the drawings, wherein:

FIG. 1 is a cross-sectional view of an embodiment of a guiding device for use in a fluid connector device, where the guiding device comprises a reconnectable fitting partially disposed in a portion of a narrow end of a body of the guiding device;

FIG. 2 is a cross-sectional view of an embodiment of a guiding device comprising a fluid conduit disposed in a passage of a body of the guiding device;

FIG. 3 is a cross-sectional view of an embodiment of a fluid connector device comprising a guiding device having a reconnectable fitting removably coupled to the coupling substrate;

FIG. 4 is a cross-sectional view of an embodiment of a guiding device comprising an integrated single piece component comprising a body and a reconnectable fitting; and

FIG. 5 is a perspective view of an embodiment of an assembly comprising a plurality of bodies that are coupled to a common base component.

### DETAILED DESCRIPTION

One or more embodiments of the guiding devices of the invention, for use in fluid connector devices, facilitate interfacing of microfluidic devices with each other or with external fluidic components and systems. Non-limiting examples of the fluidic components include pumps, filters, syringes, aerosol collectors, flow cytometers, purification systems, and chemical analyzers. In one embodiment, a guiding device may facilitate coupling of at least one fluid conduit to a corresponding port of a microfluidic device using a reconnectable fitting. The reconnectable fitting may be used for introducing or extracting fluids (liquids or gases) from the microfluidic device.

In certain embodiments, a fluid connector device comprises a coupling substrate having one or more conformal recesses, a reconnectable fitting configured to be disposed in the conformal recess to provide a passageway, a guiding device configured for guiding the reconnectable fitting in the conformal recess for removably coupling the reconnectable fitting and the conformal recess. The guiding device comprises a base component, and a body slidably disposed in the base component. The body may comprise a broad end and a narrow end, the broad and narrow ends are disposed on opposite sides of the base component. The broad end is disposed away from the coupling substrate. The reconnectable fitting is configured to be disposed in the narrow end. The guiding device further comprises a resilient component disposed on the body of the guiding device. The resilient component, body and junction between the base component and the body are configured to move the reconnectable fitting one or more degrees in a translational, or a rotational direction, or both, relative to the coupling substrate. The fluid connector device further comprises a force applying element operatively coupled to the guiding device, or the coupling substrate, or both the guiding device and the coupling substrate to at least partially provide a sealing force between the reconnectable fitting and the coupling substrate, wherein at least one of the force applying element, the reconnectable fitting, and the coupling substrate comprises one or more degrees of freedom for self-alignment of the reconnectable fitting and the conformal recess. In one embodiment, the force applying element may provide a sealing force to the guiding device. The guiding device may then transfer the sealing force to the reconnectable fitting. The fluid connector assembly is designed such that degrees of freedom for the body and fitting may change during translational or rotational movement of the body in order to allow for precise positioning of the fitting in the initial state, and increasing self-alignment capabilities of the fitting during application of a sealing force.

In certain embodiments, it may be desirable to have sufficient degrees of freedom for the movement of the reconnectable fitting. The translational and rotational movements of the reconnectable fitting may enable self-alignment of the geometries of the reconnectable fitting and the conformal recess during operation. For example, translational and rotational movements of the reconnectable fitting may be desirable to provide self-alignment capabilities that may compensate positioning tolerances and result in improved sealing between the reconnectable fitting and the microfluidic chip. Also, the degrees of freedom for the movement of the reconnectable fitting minimizes built-up of stresses within the system, thereby improving the sealing behavior. In case of a plurality of fluid connector devices being employed, the translational and rotational movements of the reconnectable fitting avoid interaction between the plurality of fluid connector devices. The guiding device provides the desired number of degrees of freedom for self-aligning the reconnectable fitting in the conformal recess. Further, the guiding device provides the desired number of degrees of freedom to the reconnectable fitting to form a reliable seal between the coupling substrate and the reconnectable fitting while reducing the stresses in the fluid connector device.

In one embodiment, the coupling substrate may be the device substrate. For example, the coupling substrate may be the microfluidic device (e.g. a microfluidic chip), and the conformal recess may be formed in the microfluidic device. In certain embodiments, the micro-fabricated fluidic device or microfluidic device may have one or more ports for introducing or withdrawing fluids from the microfluidic devices. In addition, the microfluidic device may include one or more channels for conducting chemical analyses, chemical synthesis, mixing fluids, or separating components from a mixture that are in fluid communication with the ports. In certain embodiments, the microfluidic device may have dimensions ranging from picolitres to milliliters. The fluid connector device enables introducing microliter and sub-microliter quantities of solutions into the microfluidic device without leak. In one embodiment, the microfluidic device may be in operative association with external components such as channels, pumps, valves, sensors, reaction chambers, particle separators, and electronics. The guiding device of the fluid connector device enables interfacing between microfluidic devices and the components.

In certain embodiments, the microfluidic device may be part of a lab on a chip and may employ one or more microfluidic channels. In one example, the lab on a chip may include a disk or block (a “chip”) made of a material, e.g. a plastic, in which microchannels are formed. The microchannels open into chambers where the samples flowing through the microchannels may be reacted with reagents. The results of the reactions may be observed through the transparent disc or block walls and/or the products of the reactions may be output from the chip for further processing or analysis.

The reconnectable fitting and the microfluidic device may be pressed against each other to form a seal between the microfluidic device and the reconnectable fitting. During this sealing process it is desirable that the reconnectable fitting is able to move relative to its counter-part to self-align and to reduce stress in the system. This self-alignment is also desirable during the operation of the fluid connector device. However, the self-alignment becomes increasingly difficult with the increasing number of reconnectable fittings that are coupled to corresponding conformal recesses. For example, it is difficult to provide the required degrees of freedom to every reconnectable fitting coupled to a common structure, such as a support plate. In certain embodiments, the desired degrees of freedom may be provided to each of the reconnectable fittings coupled to a common base component of the guiding device for the purpose of self-aligning for sealing and operation of the device.

The guiding device provides flexibility for scale-ups. For example, depending on the size of the guiding device, a greater number of reconnectable fittings may be disposed in a guiding device. Therefore, a greater number of ports of the microfluidic device may be interfaced. The guiding device comprises a self-aligning connection, which is adaptable to individual microchip assemblies having a determined fitting density (or port density). Also, the guiding devices and the fluid connector devices comprising the guiding devices may be manufactured in a rapid prototyping environment. In case of the microfluidic assembly employing two or more fluid connector devices, each of the reconnectable fittings may be in operative association with a corresponding body but a common base component. In one embodiment, each of the reconnectable fittings is mechanically decoupled from the others to allow independent self-alignment and application of constant force.

The reconnectable fitting fits in the conformal recess of the microfluidic device to provide a first passageway to a corresponding port of the microfluidic device. The degrees of freedom provided by the guiding device enable the reconnectable fitting to be disposed back in the conformal recess after being at least partially moved away (dislocated) from a determined position in the conformal recess during the operation of the device. For example, the reconnectable fitting may be disposed back in the determined position in the conformal recess after being at least partially ejected out of the conformal recess during operation of the device. In one embodiment, one or more fluid conduits may be disposed in the passageway for enabling transfer of fluids or gases between external devices and the microfluidic device. The fluid conduits may be disposed in a passage formed in the body. Alternatively, the passage in the body may be configured to carry out the functions of a fluid conduit.

In certain embodiments, the guiding device may be coupled (e.g. using a clamp) to a support structure, such as a planar support plate, L-shaped structure, U-shaped structure or clamp stand, to hold the fluid connector device in place. In these embodiments, the base component of the guiding device may be in operative association with a support structure. In one embodiment, the support structure may be configured to undergo deformation. For example, when the support structure is the flexure, the support structure may open up under deformation. In one embodiment, the support structure may be made of metal, ceramic, polymer or combinations thereof.

In one embodiment, the guiding device may be decoupled from the fluid connector device after providing a seal between the coupling substrate and the reconnectable fitting. In these embodiments, the reconnectable fitting is configured to decouple from the body of the guiding device. Subsequently, if required, the guiding device may be re-coupled with the microfluidic assembly/reconnectable fitting.

In another embodiment, the guiding device may stay coupled to the reconnectable fitting during operation of the fluid connector device. For example, the reconnectable fitting may be permanently coupled to the guiding device. That is, the reconnectable fitting may not be configured to be decoupled from the guiding device after forming the seal between the reconnectable fitting and the coupling substrate. If the reconnectable fitting is permanently fitted, to move the reconnectable fitting from its position, the guiding device may be used to facilitate self-alignment of the reconnectable fitting in the conformal recess. In one example, the resilient component may exert continuous pressure on the reconnectable fitting to retain the reconnectable fitting in the desired position in the conformal recess.

In one embodiment, the reconnectable fitting and the body of the guiding device may form a single piece structure. In this embodiment, the body and the reconnectable fitting may be made of same material. The material of the body and the reconnectable fitting may be configured to undergo thermal or pressure induced material yielding during sealing and operation of the device. That is, when the reconnectable fitting is pressed against the coupling substrate, the yielding of the material of the single piece body and reconnectable fitting the material of the reconnectable fitting may be configured to undergo thermal or pressure induced material yielding while being disposed in the conformal recess.

In one embodiment, the base component or the body, or both may be made of metal, semiconductor, ceramic, polymer or combinations thereof. The base component and the body may be made of same or different materials. The material of the base component and the body may be corrosion resistant and suitable for lab environments. In one embodiment, the shape of the body may comprise a converging shape, such as but not limited to, a conical shape, parabolic shape, trapezoidal shape, pyramidal shape, hemispherical shape, barrel shape or combinations thereof.

The conformal recess, body of the guiding device (e.g. single piece reconnectable fitting and body) or the reconnectable fitting, or both the conformal recess and the reconnectable fitting may undergo either elastic or plastic deformation to provide a seal between the reconnectable fitting and the coupling substrate. In one example, only the conformal recess undergoes deformation, such as an elastic deformation. In another example, both the conformal recess and the reconnectable fitting may undergo deformation. In this example, the conformal recess may undergo elastic deformation, and the reconnectable fitting may undergo plastic deformation.

The material of the coupling substrate, reconnectable fitting or both may be chosen based on the deformation properties (elastic or plastic deformation) of the material, or values of the temperature and pressure, and type of fluids that the fluid connector device may be exposed to. The materials of the coupling substrate and/or the reconnectable fitting or the body of the guiding device (e.g. single piece reconnectable fitting and body) are configured to undergo at least partial deformation. In instances where the body and the reconnectable fitting form a single-piece element, the single piece may be formed of one or more materials used for forming the coupling substrate or the reconnectable fitting. In certain embodiments, the materials of the coupling substrate and/or the reconnectable fitting may comprise glass, metals, semiconductors, ceramics, polymers, or combinations thereof. The material for the coupling substrate or the body of the guiding device (e.g. single piece reconnectable fitting and body) or the reconnectable fitting may be such that one or more conformal recesses can be formed in the coupling substrate. The material of the coupling substrate may be chosen based on the ease of forming the desired recess shape in the substrate material. For example, it may be easier to form a conical or a tapered recess in a polymer substrate than a metal substrate, semiconductor substrate or ceramic substrate, such as a glass substrate. The polymers for the coupling substrate and/or the reconnectable fitting may be soft or hard polymers. Soft polymers refer to elastomer type materials such as, but not limited to, polydimethylsiloxane, a copolymer of hexafluoropropylene (HFP) and vinylidene fluoride (VDF or VF₂), a terpolymer of tetrafluoroethylene (TFE), vinylidene fluoride (VDF), and hexafluoropropylene (HFP), perfluoromethylvinylether (PMVE), nitrile rubber, and thermoplastic elastomers such as ELASTRON® and THERMOLAST®. Hard polymers refer to materials such as, but not limited to, polyether ether ketone (PEEK), polypropylene, poly(methyl methacrylate) (PMMA), polyethelene, olefin copolymers (e.g. TOPAS®), modified ethylene-tetrafluoroethylene) fluoropolymer (ETFE) (e.g. TEFZEL®), polyetherimide (e.g. ULTEM®), cyclic olefin copolymer (COC), and the like.

In certain embodiments, the shape of the conformable recess may include a tapered geometry. The shape of the recess may include any tapered geometries that can receive the reconnectable fitting and form a leak proof seal with the reconnectable fitting. Non-limiting examples of tapered geometries for the conformal recess may include a conical shape, parabolic shape, trapezoidal shape, pyramidal shape, hemispherical shape, barrel shape, or combinations thereof. As with the conformal recess, the reconnectable fittings may include tapered geometries such as but not limited to, conical shape, parabolic shape, trapezoidal shape, pyramidal shape, hemispherical shape, barrel shape, or combinations thereof, or any other geometries that forms a leak proof seal with the tapered geometry of the conformal recess. In the case of the fittings having conical shape, the fittings may be standard conical fittings. Optionally, the conformal recess, and/or the tapered geometry of the reconnectable fitting that is configured to be disposed in the conformal recess may include a surface modification.

In certain embodiments, the fluid connector device comprises a force applying element. The force applying element provides a sealing force between the reconnectable fitting and the coupling substrate. The force applying element may be made of a material that may apply a force that does not change substantially when the material is compressed by a few microns. In other words, the force applying element may be made of a material that is able to proportionally translate a determined deformation of the material of the force applying element into a determined force. Non-limiting examples of the force applying element may include a spring, lever-like structure, flexure, gas based structure (e.g. a flexible gas channel), vacuum based structure, fluid based structure (e.g. a flexible fluid channel), compressive structure, hydraulic transducer, pneumatic transducer, magnetic transducer, thermal transducer, mechanic transducer, an electro-mechanic transducer, an electrostatic transducer, electromagnetic transducer or combinations thereof. Non-limiting examples of flexure may include a lever-like structure (e.g. cantilever), U-shaped structure, V-shaped structure.

In one embodiment, the force applying element may be operatively coupled to the body or the base component to transfer the force from the force applied component to the guiding device. In addition, at least one of the force applying element, the reconnectable fitting, and the coupling substrate provides one or more degrees of freedom for the movement of the reconnectable fitting. The force applying element provides degrees of freedom to the reconnectable fitting along one or more of x, y or z-directions. In one embodiment, the sealing force provided by the force applying element may deform either the reconnectable fitting, or the coupling substrate, or both. The sealing force enables the formation of a fluid and gas tight seal. In one embodiment, at least a portion of the conformal recess, or the reconnectable fitting, or both the conformal recess and the reconnectable fitting may undergo at least partial deformation to provide a leak proof seal. In one example, the conformal recess may undergo deformation to acquire the shape of a portion of the fitting being disposed in the recess and to provide a leak proof seal. The conformal recess may deform around a tapered end of the reconnectable fitting to provide a leak-proof seal around the tapered portion of the reconnectable fitting. In one example, the reconnectable fitting and the coupling substrate may be made of PEEK, in this example, the reconnectable fitting and the coupling substrate may be sealed by thermal treatment.

In one embodiment, during operation of the fluid connector device, the force applying element may apply a continuous force to the guiding device to maintain a leak proof seal between the reconnectable fitting and the conformal recess. In another embodiment, the force applying element may provide a discontinuous force to the guiding device. In this embodiment, the force applying element may provide force in one or more steps. For example, in one step, the force applying element may provide a sealing force via the guiding device to seal the reconnectable fitting and the coupling substrate, and in the second and last step (post operation of the fluid connector device), the force applying element may provide a force via the guiding device to de-couple the reconnectable fitting and the coupling substrate. In this way, the force applying may enable both coupling and de-coupling of the component reconnectable fitting and the coupling substrate. Once decoupled, the fluid connector device may be used with other devices, such as other microfluidic chips.

The microfluidic device may be made of any suitable material, such as but not limited to, silicon, glass, ceramics, polymers or plastic. The microfluidic device may be fabricated using fabrication techniques, such as but not limited to, photolithography, etching, electroplating, thin film deposition, conventional machining, laminating, embossing and bonding. The microchannels in the microfluidic device may be etched, milled, embossed, or molded into the surface of a suitable substrate and may be enclosed by bonding another substrate over the etched or impressed side of the first substrate to produce a microfluidic device.

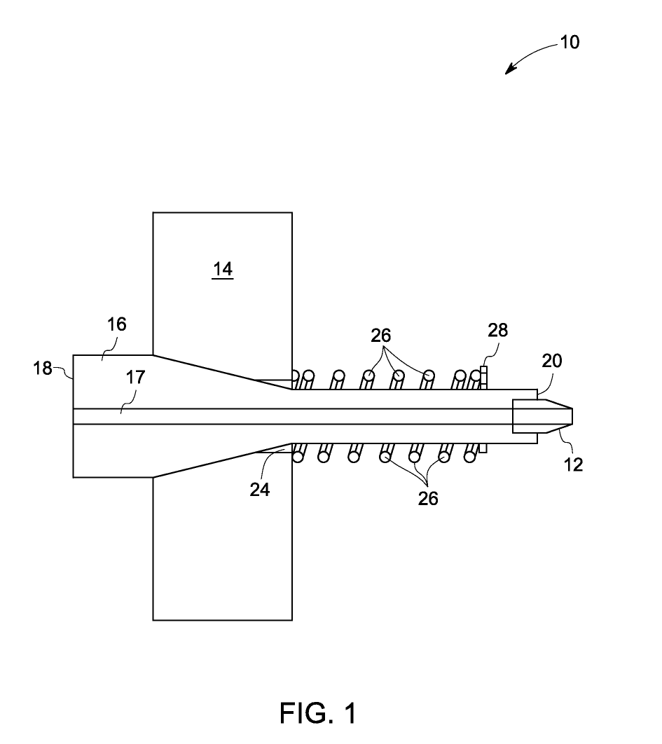

FIG. 1 illustrates a guiding device 10 for guiding a reconnectable fitting 12 in a conformal recess of a microfluidic device (not shown) for removably coupling the reconnectable fitting 12 to the conformal recess. The guiding device 10 comprises a base component 14 and a body 16. The broad and narrow ends 18 and 20, respectively, are disposed on opposite sides of the base component 14. Generally, the narrow end 20 is disposed closer to the conformal recess, and the broad end 18 is disposed away from the conformal recess. In one embodiment, the narrow end may have a rectangular cross-section, a circular cross-section, an oval cross-section, an ellipsoidal cross-section, or combinations thereof. In the illustrated embodiment, the reconnectable fitting 12 is coupled to the narrow end 20. The reconnectable fitting 12 may be configured to be decoupled from the body 16 after a sealing of the reconnectable fitting 12 and the conformal recess. In another embodiment, the reconnectable fitting 12 may be permanently disposed in the body 16 or on the microfluidic device. In this embodiment, the reconnectable fitting 12 may not decoupled from the body 16 after formation of a sealing between the reconnectable fitting and the conformal recess in the microfluidic device. The body 16 may comprise a passage 17 running between the narrow end and the broad end 20. In embodiments where the reconnectable fitting 12 is temporarily disposed in the body 16, the passage may be used to dispose a fluid conduit (not shown). In embodiments where the reconnectable fitting 12 is not configured to be decoupled from the body 16, the passage 17 may be used for transporting fluids. In these embodiments, a separate fluid conduit may not be disposed in the passage 17. Typically, when the passage 17 that is used as a fluid path the passage 17 may be narrower than the passage that employs fluid conduits (such as a capillary tube).

The base component 14 may be any shape, such as a plate, that enables the body to be slidably disposed inside it. The body 16 is slidably disposed in a recess 24 formed in the base component 14. The recess 24 provides a framework to the body 16 to slide within to provide desired degrees of freedom for guiding the reconnectable fitting in the conformal recess of the microfluidic device while minimizing generation of stresses in the system. In one example, translational and rotational movements may be supported by a bushing that may be a part of the base component 14, body 16 or both. The converging shape of the body 16 provides the flexibility to the body 16 to move up and down (direction perpendicular to sliding direction of the body 16 in the base component 14) while sliding in and out of the base component 14. Materials of the base component 14, body 16 or the bushing insert of the base component may be selected to support the sliding properties between the body 16 and base component 14. Non-limiting examples of the materials of the base component 14, body 16 or the bushing insert may comprise brass, ceramics, polytetrafluoroethylene (e.g. TEFLON®) or comparably low-friction and self-maintaining materials usually utilized for sliding mechanisms.

The guiding device 10 further comprises a resilient component 26 disposed on the body 16 of the guiding device 10. The resilient component 26 may be configured to provide one or more degrees of freedom for facilitating sealing between the reconnectable fitting and the microfluidic device while minimizing undesired stresses in the system. The degrees of freedom provided by the resilient component 26 may comprise one or more of a translational, or a rotational, or both translational and rotational degrees of freedom to the reconnectable fitting 12.

The resilient component 26 may be disposed either near the broad end 18 or the narrow end 20 of the body 16 depending on the shape of the body 16. In one embodiment, the resilient component 26 may be disposed near both the broad end 18 and the narrow end 18. In the illustrated embodiment, the resilient component 26 is disposed on a portion of the outer surface of the body 16 of the guiding device 10. Alternatively, the resilient component 26 may be disposed on opposite surfaces over a portion of the body 16. The resilient component 26 comprises a spring constant and may be one or more of springs, elastomer structures (e.g. rubber structures), flexures, a pneumatic element, an electro-mechanic element, a hydraulic element, or combinations thereof. For example, a plurality of rubber structures may be disposed on opposite sides of a portion of the body 16 disposed between the base component 14 and the narrow end 20. In one example, the body 16 may be a part of or coupled to an electro-mechanic actuator, a hydraulic actuator, a pneumatic actuator, or combinations thereof. The type of resilient component 26 used may depend on whether the resilient component 26 is disposed closer to the broad end 18 or the narrow end 20. For example, in instances where the resilient component 26 is disposed closer to the broad end 18, the resilient component 26 may comprise an expansion element, such as a tension spring. The expansion elements are configured to go back to original state when expanded and left. In instances where the resilient component 26 is disposed closer to the narrow end 20, the resilient component 26 may comprise a compression element, such as one or more compression springs. The compression elements are configured to retrieve to original state when compressed and relieved. In one example, the guiding device 10 may include an expansion element between the broad end 18 and the base component 14 and a compression element between the narrow end 20 and the base component 14.

The guiding device 10 further comprises a mechanical stopper 28 disposed between the narrow end 20 and the resilient component 26. The mechanical stopper 28 is configured to provide mechanical resistance to the resilient component when the resilient component yields under the pressure experienced during the sealing or operation of the guiding device. The mechanical stopper 28 may be required when employing the resilient component 26 closer to the narrow end 20 of the body 16. The mechanical stopper 28 may be in the form of a plate, bar, block, or any other structure that is configured to provide mechanical resistance to the resilient component 26.

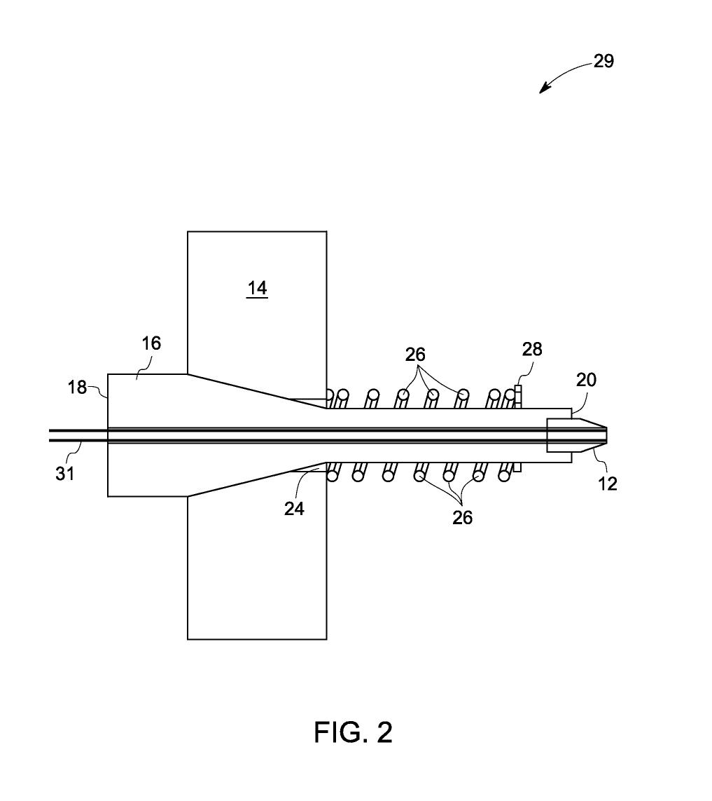

FIG. 2 illustrates the guiding device 29 having a fluid conduit 31 disposed in the passage 17 of the body 16. In the illustrated embodiment, the fluid conduit 31 is comprises a single capillary tube. However, two or more fluid conduits may also be disposed in the passage 17. The fluid conduit may run through the passage 17 to the reconnectable fitting 12. Post sealing, the guiding device 29 may be decoupled from the reconnectable fitting 12 while leaving the fluid conduit 31 coupled to the reconnectable fitting 12.

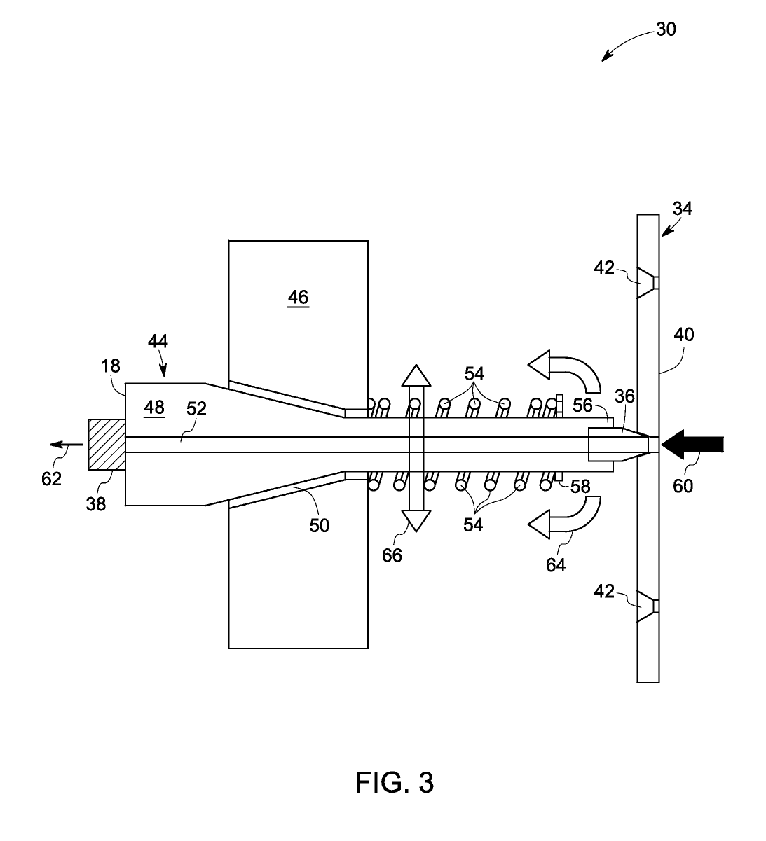

Referring to FIG. 3, a fluid connector device 30 comprises the guiding device 32. The fluid connector device 30 further comprises a microfluidic device 34, a reconnectable fitting 36, and a force applying element 38. The fluid connector device 30 may be used for connecting external liquid flow streams to the mini- or microfluidic device 34. In the illustrated embodiment, the microfluidic device 34 is formed of a device substrate 40 having a plurality of conformal recesses 42. The microfluidic device 34 further includes one or more mini- or microfluidic channels (not shown) disposed in the device substrate 40. The plurality of microfluidic channels may be a part of the network (not shown) of microfluidic channels of the microfluidic device 34. Non-limiting examples of the microfluidic channels may be a reactor, an electrophoretic separation channel, or a liquid chromatography column. In addition, other appropriate hardware may be present, e.g., electrodes, pumps and the like, to practice the intended application, e.g., electrophoretic migration and/or separation, or chromatographic separation. Although not illustrated, in some embodiments, the fluid connector device 30 may be used to connect two independent (not interconnected) channels of the same microfluidic device 34 to each other to allow fluid communication between the two independent channels.

The fluid connector device 30 comprises a guiding device 44 having a base component 46 and a body 48. The base component 46 comprises a recess 50 where the body 48 is slidably disposed. The body 48 comprises a passage 52 that may function as a fluid conduit. Alternatively, a separate fluid conduit may be disposed in the passage 52. A resilient component 54 is disposed on an outer surface near the narrow end 56 of the body 48. In the illustrated embodiment, the resilient component 54 is a spring that is disposed around the outer surface of the body 48. The force applying element 38 and the guiding device 44 at least partially provides sealing force between the reconnectable fitting 36 and the coupling substrate 40. In operation, the guiding device 44 may be configured to relieve stress at the interface between the microfluidic device 34 and the reconnectable fitting 36. During operation, the guiding device 44 allows the force exerted by the flowing fluid to be compensated.

In one embodiment, a force may be applied on the guiding device 44, for example, during sealing. In the illustrated embodiment, the force may be applied in a direction represented by the arrow 60. The force represented by arrow 60 may be applied by pressing the microfluidic device 34 towards the fluid connector device 30. Upon application of the force, as illustrated by arrow 62, the body 48 slides in the base component 46 in the direction of applied force (arrow 60). The force may also be applied to the base component 46 in opposite direction of arrow 62. Due to the sliding of the body 48 in the base component 46, a counter force is generated by the resilient component 54 as the resilient component 54 is compressed between the base component 46 and the mechanical stopper 58, thereby providing a sealing force between the reconnectable fitting 36 and the conformal recess 42. As illustrated by arrows, the design of the guiding device provides it rotational (arrows 64) and translational (arrow 66) degrees of freedom. The converging shape in combination with the slidable nature of the body 48 provides the desired degrees of freedom in the fluid connector device 30. In one embodiment, the position of the fluid connector device 30 changes discretely or continuously such that the reconnectable fitting 36 matches the corresponding recess on the microfluidic chip 40. The resilient component 54, the body 48, and the junction between the body 48 and the base component 46 allows a continuous or discrete (step-wise) transition from an initial relatively greater positioning accuracy of the reconnectable fitting 36 in the conformal recess of the microfluidic device 34 and low degrees of freedom to relatively lower positioning accuracy of the reconnectable fitting 36 in the conformal recess and increased degrees of freedom.

The guiding device 44 provides an amount of force on a portion of the reconnectable fitting 36 that is sufficient to create a face seal capable of withstanding high-pressure. In one example, the fluid connector device 30 may be successfully operated at pressures ranging from about 0 bars to about 500 bars.

The degrees of freedom provided by the guiding device enables the fluid connector device 30 to endure high pressure regimes while causing minimal or no physical damage to the fluid connector device 30 or the microfluidic device 34. For example, the guiding device 44 may prevent undesired deformation, or movement of the reconnectable fitting 36 in presence of high pressures, such as the high force of the fluid entering or exiting the fluid conduits.

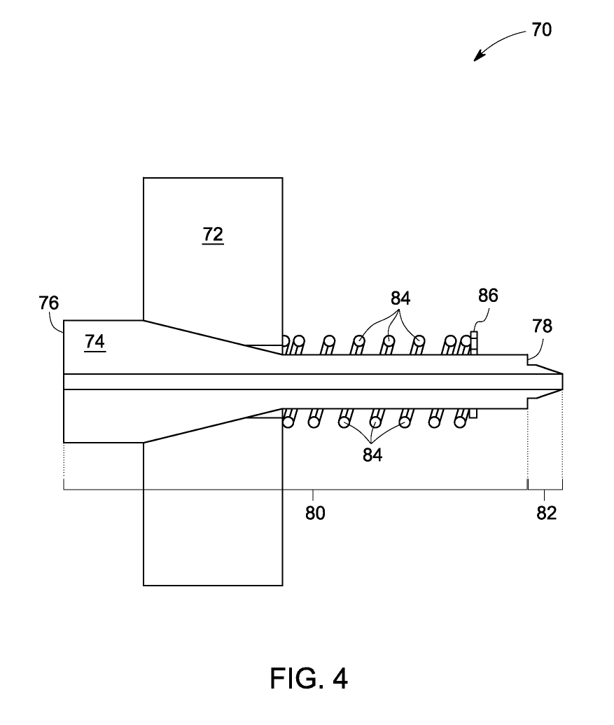

FIG. 4 illustrates an alternate embodiment of the guiding device. In the illustrated embodiment, the guiding device 70 comprises a base component 72 and a single piece component 74. The single piece component 74 is a continuous structure between a broad end 76 and a narrow end 78. The single piece component 74 may be divided into two parts: (1) a body 80, and (d) a reconnectable fitting 82. The body 80 and the reconnectable fitting 82 are formed as one single piece. In one embodiment, there is no joint present between the body 80 and the reconnectable fitting 82. The single piece component 74 may be formed by processes such as but not limited to, extrusion, molding. The single piece component 74 is partly disposed in the base component 72. The guiding device 70 further comprises a resilient component 84 disposed on the single piece component 74. In the illustrated embodiment, the resilient component 84 is disposed closer to the narrow end 78, and between the base component 72 and a mechanical stopper 86. In alternate embodiments, the resilient com 84 may be disposed closer to the broad end 76 of the body 80, and between the broad end 76 and the base component 72.

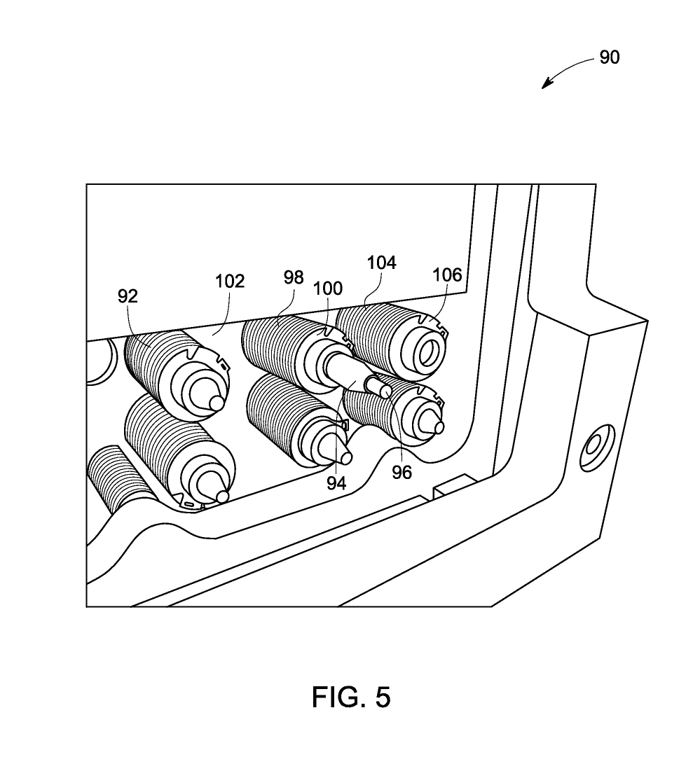

FIG. 5 illustrates a portion of fluid connector assembly 90 having fluid connector devices 92. The fluid connector devices 92 include reconnectable fittings 94, and a coupling substrate (not shown), such as a microfluidic chip. Fluid conduits 96 extend through passageways in the reconnectable fittings 94 using capillaries to connect to ports on the microfluidic chip. The fluid conduits 96 may be used for fluid inlet and fluid outlet for the microfluidic chip. In the illustrated embodiment, reconnectable fittings 94 are at least partly disposed in bodies 98 of guiding device 100. The guiding device 100 comprises a base component 102.

Advantageously, the different forces associated with the different reconnectable fittings 94, are decoupled from each other due to the use of individual resilient components 104 disposed between the base component 102 and a corresponding mechanical stopper 106. Decoupling of the different forces associated with the different reconnectable fittings 94 makes the forces more precise, and avoids excess interaction between fittings 94 that may otherwise result in leakage of fluid. In addition, since the reconnectable fittings 94 are independent of each other, one or more of the reconnectable fittings 94 may undergo translational or rotational movements to maintain the fluid tight seal. In the event of one or more of the reconnectable fittings 94 being moved away from the determined position, the reconnectable fittings 94 are configured to self-align themselves into the corresponding conformal recesses.

In certain embodiments, the fluid connector device may be provided in the form of an adapter kit that is retrofitted in a conventional microfluidic device. The adapter kit may be either reusable or disposable. The removably connected fluid connector device enables retrofitting the fluid connector device in new or existing (conventional) systems, with minimal, or no alteration to the existing systems. Also, in case of failure of any of the components of the fluid connector device, the device can be decoupled from the microfluidic system, and either another fluid connector device, or the same fluid connector device post repair, may be coupled to the microfluidic system.

Although not illustrated, in one embodiment, the adapter kit may be used to connect reagent storage devices, transfer, and transfer and/or reactor vessels to a small-scale device such as a microfluidic device. In one example, a reagent storage device having a tapered end may be used as the reconnectable fitting. Other modifications are possible without departing from the scope of the invention. For example, each of the reconnectable fittings may be coupled, for example, clamped, to individual support components to provide required strength to the system, and to hold the fluid connector devices in place. Advantageously, the re-connectivity and flexibility of the fluid connector device in the system requires lesser calibrations with regard to undesired environmental perturbations, such as vibrations etc.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A fluid connector device, comprising:
a coupling substrate comprising a conformal recess;
a reconnectable fitting corresponding to the conformal recess;
a guiding device comprising:
a base component;
a body at least partly disposed in the base component and comprising a broad end and a narrow end, wherein the broad end is disposed away from the coupling substrate, and wherein the body is slidably disposed in the base component, and
a resilient component disposed on the body of the guiding device and configured to move the reconnectable fitting one or more degrees in a translational, or a rotational direction, or both, relative to the coupling substrate;
a force applying element operatively coupled to the guiding device, the coupling substrate, or both, to at least partially provide a sealing force between the reconnectable fitting and the coupling substrate, wherein at least one of the force applying element, the reconnectable fitting, and the coupling substrate are adapted to move one or more degrees to enable self-alignment between the reconnectable fitting and the conformal recess.

2. The fluid connector device of claim 1, wherein the resilient component comprises a spring, an elastomer structure, a flexure, a pneumatic element, an electro-mechanic element, a hydraulic element, or a combination thereof.

3. The fluid connector device of claim 1, wherein the resilient component comprises a spring constant.

4. The fluid connector device of claim 1, wherein the resilient component is disposed closer to the narrow end of the body than the broad end.

5. The fluid connector device of claim 1, wherein the resilient component is disposed on a portion of the body of the guiding device.

6. The fluid connector device of claim 1, wherein the resilient component is disposed closer to the broad end of the body than the narrow end.

7. The fluid connector device of claim 1, wherein the base component or the body, or both may be made of a metal, semiconductor, ceramic, polymer, or combinations thereof.

8. The fluid connector device of claim 1, wherein the base component comprises a bushing.

9. The fluid connector device of claim 1, wherein a shape of the body is trapezoidal, barrel, tapered, conic, spherical, or a combination thereof.

10. The fluid connector device of claim 1, wherein the reconnectable fitting is removably disposed in the narrow end of the body.

11. The fluid connector device of claim 1, wherein the narrow end of the body is a conical shape, parabolic shape, trapezoidal shape, pyramidal shape, hemispherical shape, barrel shape, or combinations thereof to receive the reconnectable fitting.

12. The fluid connector device of claim 1, wherein the base component and the body form a single piece component.

13. The fluid connector device of claim 1, wherein the resilient component is configured to provide translational and rotational degrees of freedom to the guiding device.

14. The fluid connector device of claim 1, further comprising a mechanical stopper disposed between the resilient component and the narrow end.

15. The fluidic connector device of claim 1, further comprising a support structure coupled to the coupling substrate, or the guiding device, or both, wherein the support structure is coupled to the coupling substrate, or the guiding device, or both.

16. A fluid connector assembly, comprising
a coupling substrate having a first surface and a second surface, the coupling substrate comprising one or more conformal recesses on the first surface;
one or more reconnectable fittings that are configured to be at least partially disposed in the conformal recess to provide a passageway between the microfluidic device and the reconnectable fittings such that the reconnectable fittings are in fluidic communication with the microfluidic device;
a guiding device for guiding the reconnectable fitting in the conformal recess for removably coupling the reconnectable fitting to the conformal recess, wherein the guiding device comprises:
a base component;
a body at least partly disposed in the base component and comprising a broad end and a narrow end, wherein the broad end is disposed away from the coupling substrate, and wherein the body is slidably disposed in the base component, and
a resilient component disposed on the body of the guiding device and configured to move the reconnectable fitting one or more degrees in a translational, or a rotational direction, or both, relative to the coupling substrate;
a force applying element operatively coupled to the guiding device, the coupling substrate, or both, to at least partially provide a sealing force between the reconnectable fitting and the coupling substrate, wherein at least one of the force applying element, the reconnectable fitting, and the coupling substrate are adapted to move one or more degrees to enable self-alignment between the reconnectable fitting and the conformal recess; and
a support structure in operative association with the force applying element.

17. The fluid connector assembly of claim 16, wherein the support structure comprises a planar support plate, L-shaped structure, U-shaped structure, clamp stand, or combinations thereof.

18. An adapter kit for introducing and/or extracting fluids from a microfluidic device, the adapter kit comprising:
a coupling substrate having a first surface and a second surface, wherein the first surface comprises a conformal recess;
a reconnectable fitting corresponding to the conformal recess;
a guiding device, comprising:
a base component;
a body at least partly disposed in the base component and comprising a broad end and a narrow end, wherein the broad end is disposed away from the coupling substrate, and wherein the body is slidably disposed in the base component, and
a resilient component disposed on the body of the guiding device and configured to move the reconnectable fitting one or more degrees in a translational, or a rotational direction, or both, relative to the coupling substrate;
a force applying element operatively coupled to the guiding device, the coupling substrate, or both, to at least partially provide a sealing force between the reconnectable fitting and the coupling substrate, wherein at least one of the force applying element, the reconnectable fitting, and the coupling substrate are adapted to move one or more degrees to enable self-alignment between the reconnectable fitting and the conformal recess.
